(19) United States
(12) Patent Application Publication
(10) Pub. No.: US 2015/0185947 A1
(43) Pub. Date: Jul. 2, 2015

(54) METHOD AND ELECTRONIC DEVICE FOR MANAGING EVENT NOTIFICATION

(71) Applicant: Acer Incorporated, New Taipei City (TW)

(72) Inventors: Hsiao-Lan Tsai, New Taipei City (TW); Wei-Jhe Huang, New Taipei City (TW); Wei-Hung Chin, New Taipei City (TW)

(21) Appl. No.: 14/480,638

(22) Filed: Sep. 9, 2014

(30) Foreign Application Priority Data
Dec. 26, 2013 (TW) 102148491

(51) Int. Cl. G06F 3/041; G06F 3/0488

(52) U.S. Cl. CPC G06F 3/0416; G06F 3/0488

(57) ABSTRACT

A method and an electronic device for managing an event notification are provided. The method for managing the event notification is adapted for the electronic device having a touch screen, and the method includes following steps. At least one event triggered through at least one application program is detected. A notification of each of the at least one event is displayed on the touch screen. A first touch operation performed on one of the notifications is received. According to the received first touch operation, deletion of the one of the notifications is prompted, and a blocking option is displayed. A second touch operation performed on the blocking option is received, and an event notification function associated with the one of the notifications in the application program corresponding to the one of the notifications is disabled according to the received second touch operation within a set period.

### CROSS-REFERENCE TO RELATED APPLICATION

This application claims the priority benefit of Taiwan application serial no. 102148491, filed on Dec. 26, 2013. The entirety of the above-mentioned patent application is hereby incorporated by reference herein and made a part of this specification.

### FIELD OF THE INVENTION

The invention relates to an electronic device; more particularly, the invention relates to a method for managing an event notification and an electronic device using the method.

### DESCRIPTION OF RELATED ART

As mobile communication technology becomes more and more advanced, mobile electronic devices have become indispensable in modern people's lives. In addition to the basic functions of receiving and answering calls, the existing mobile electronic devices are also capable of receiving and sending e-mails and messages, browsing internet websites, and so forth. What is more, if application programs are installed into the mobile electronic devices, various functions can be performed. In a multitasking mode, the mobile electronic device is able to execute multiple application programs at the same time. To remind a user of the current status of each application program, the mobile electronic device sends a notification to the user as long as any new event is triggered through one of the application programs, so as to allow the user to review and perform relevant tasks. For instance, given that a communication application program receives a new message sent by a contact, or a social networking application program receives a news feed from a friend, the mobile electronic device notifies the user by displaying a notification on the screen and/or sending an alert via sound, vibration, and so forth.

Nevertheless, under certain conditions or at certain locations, such notification may bother the user or others nearby. For instance, during a conference, a sudden ringtone alert or multiple ongoing ringtone alerts may discomfort others. If the user intends to disable the notification function of the application program, the user is often required to manually enter the setup menu to disable the event notification function respectively corresponding to each application program. Similarly, the user may re-enable the previously disabled event notification function through performing complicated steps. As a result, both enabling the notification function of the application program and disabling the same cause significant inconvenience to the user.

### SUMMARY OF THE INVENTION

Accordingly, the invention is directed to a method and an electronic device for managing an event notification, such that a user is allowed to temporarily disable an event notification function of certain application program.

In an embodiment of the invention, a method for managing an event notification is adapted for an electronic device that is equipped with a touch screen. In the method, at least one event triggered through at least one application program is detected, and a notification of each of the at least one event is displayed on the touch screen. A first touch operation performed on one of the notifications is received; according to the received first touch operation, deletion of the one of the notifications is prompted, and a blocking option is displayed. A second touch operation performed on the blocking option is received, and an event notification function associated with the one of the notifications in the at least one application program corresponding to the one of the notifications is disabled according to the received second touch operation within a set period.

In another embodiment of the invention, an electronic device that includes a touch screen, a storage unit, and at least one processing unit is provided. The storage unit is configured to record a plurality of modules. The processing unit is coupled to the touch screen and the storage unit and configured to access and execute the modules recorded in the storage unit. The modules include a detection module, a notification displaying module, an interface control module, and a disabling module. The detection module detects at least one event triggered through at least one application program. The notification displaying module is configured to display a notification of each of the at least one event on the touch screen. The interface control module is configured to receive a first touch operation performed on one of the notifications; according to the received first touch operation, deletion of the one of the notifications is prompted, and a blocking option is displayed. The disabling module receives a second touch operation performed on the blocking option and disables an event notification function associated with the one of the notifications in the application program corresponding to the one of the notifications according to the received second touch operation within a set period.

According to the method and the electronic device for managing the event notification described above, once the electronic device detects any event that is triggered through an application program, the notification of such triggered event may be displayed on the screen. Moreover, when the user deletes such notification, the user may select to temporarily block the event notification function of the application program or the contact associated with such notification. Thereby, the complicated setup steps may be omitted, and the user is allowed to rapidly disable the event notification function in the application program, such that the user is not disturbed by the notification.

Several exemplary embodiments accompanied with figures are described in detail below to further describe the invention in details.

### BRIEF DESCRIPTION OF THE DRAWINGS

FIG. 1 is a block diagram illustrating an electronic device according to an embodiment of the invention.

FIG. 2 is a flowchart illustrating a method for managing an event notification according to an embodiment of the invention.

FIG. 3A is a schematic diagram of displaying a notification list according to an embodiment of the invention.

FIG. 3B is a schematic diagram of displaying a notification list according to an embodiment of the invention.

FIG. 4A is a schematic diagram of prompting deletion of a notification and displaying a blocking option according to an embodiment of the invention.

FIG. 4B is a schematic diagram of prompting deletion of a notification and displaying a blocking option according to an embodiment of the invention.

FIG. 5 is a schematic diagram of providing a time menu according to an embodiment of the invention.

FIG. 6 is a schematic diagram of prompting disablement of an event notification function according to an embodiment of the invention.

### DETAILED DESCRIPTION OF DISCLOSED EMBODIMENTS

According to an embodiment of the invention, an event notification triggered through an application program installed in an electronic device provided herein may be deleted by the user. Further, the deletion operation and a blocking operation are combined, such that a user may select to temporarily or within a set period disable the event notification function of the application program or the contact associated with the notification while the user intends to delete the notification. Thereby, under certain conditions or at certain locations, the user is no longer disturbed by the notification because the user may block the event notification function through performing simple steps.

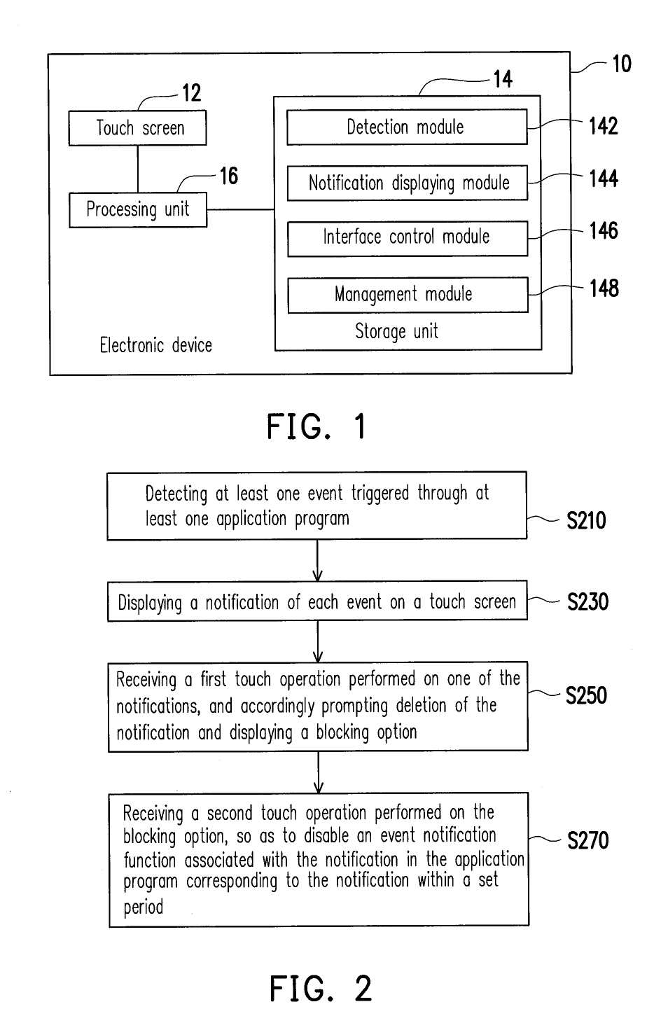

FIG. 1 is a block diagram illustrating an electronic device according to an embodiment of the invention. With reference to FIG. 1, the electronic device 10 described in the present embodiment is a mobile phone, a smart phone, a personal digital assistant (PDA), a tablet computer, an electronic book, a game console, a notebook computer, or any other electronic device equipped with a touch screen, and the invention is not limited thereto. The electronic device 10 includes a touch screen 12, a storage unit 14, and a processing unit 16, and functions of these components are separately described below.

The touch screen 12 is a display device where several touch sensing components are integrated together, so as to provide both the display function and the input function. The display device is, for instance, a liquid crystal display (LCD), a light-emitting diode (LED) display, a field emission display (FED), or any other display, which should not be construed as a limitation to the invention. The touch sensing components are configured on the display device, and the sensing components are arranged in rows and columns and are configured to receive touch operations. The touch operations include touch actions of fingers, palms, other body parts, or other objects, and the touch actions are performed on the touch screen 12. The touch sensing components may be capacitive touch sensing components, surface acoustic wave (SAW) touch sensing components, electromagnetic touch sensing components, near-field imaging touch sensing components, or the like, for instance.

The storage unit 14 is, for instance, any fixed or movable random access memory (RAM), read-only memory (ROM), flash memory, hard drive, any other similar device, or a combination thereof, and the storage unit 14 is configured to record a plurality of modules and a plurality of application programs executed by the processing unit 16.

The processing unit 16 is, for instance, a single-core or multi-core central processing unit (CPU) or other general or specific programmable microprocessor, digital signal processor (DSP), programmable controller, application specific integrated circuits (ASIC), programmable logic device (PLD), any other similar device, or a combination thereof. Besides, the processing unit 16 is coupled to the touch screen 12 and the storage unit 14 and configured to access and execute the modules and the application programs recorded in the storage unit 14.

The electronic device 10 may further include a storage device (not shown), a power supply device (not shown), an audio output device (not shown), and a signal input device (not shown), and the invention is not limited thereto. For instance, the power supply device may include a battery. The audio output device is configured to output sound signals. For instance, the audio output device may include a speaker. The signal input device is configured to receive input signals. For instance, the signal input device may include physical buttons configured on the electronic device 10, an audio input device including a microphone, and any other external signal input device.

According to the present embodiment, the modules stored in the storage unit 14 at least include a detection module 142, a notification displaying module 144, an interface control module 146, and a management module 148. These modules may be computer programs that may be loaded into the processing unit 16; accordingly, the electronic device 10 is able to manage the notifications sent by the application programs according to the touch operations of the user. The storage unit 14 stores at least one application program that can also be loaded into and executed by the processing unit 16, so as to provide corresponding functions. For instance, the application program may be a social networking application program. When the processing unit 16 executes the social networking application program, the user is able to receive messages from a friend through the electronic device 10. The application program may also be a music playing program. When the processing unit 16 executes the music playing program, the user may listen to the music through the electronic device 10. The application program may be an electronic calendar or any other widget as well. Note that the types of the application programs are not limited in the invention, and the application programs may be downloaded via the internet and installed by the user or built in the electronic device 10 by the manufacturers. Details of the method for managing an event notification via the electronic device 10 are explained in the following embodiment.

FIG. 2 is a flowchart illustrating a method for managing an event notification according to an embodiment of the invention. With reference to FIG. 2, the method provided in the present embodiment is adapted for the electronic device 10 shown in FIG. 1, and details of the method for managing the event notification are provided with reference to the components of the electronic device 10.

In step S210, the detection module 142 detects at least one event triggered through at least one application program. The application programs may trigger different events in light of different types and functions of the application programs. For instance, the application programs and the corresponding events may be an e-mail application program receiving e-mails, an electronic calendar application program reminding a user of important schedules, a messaging application program receiving messages, or a social networking application program receiving news feed from a friend; however, the invention is not limited thereto. In order to provide good services or for advertising purposes, application program developers may send information of executing certain application programs (e.g., information of updates) or other eye-catching information to the electronic device 10 where the application programs are installed. Hence, the events triggered through the application programs may include the information received from the application program developers.

In step S230, the notification displaying module 144 displays a notification of each event on the touch screen 12. To be specific, the notification displaying module 144 may generate notifications respectively associated with individual events according to the contents of the events and display the notifications on the touch screen 12. For instance, when an e-mail application program receives a new e-mail, the notification displaying module 144 may generate the notification associated with the event according to the title and the sender of the mail; when an electronic calendar application program intends to remind the user of any important schedule, the notification displaying module 144 may display a notification that includes the contents of the schedule and the time of such reminder; when a social networking application program receives information of a contact, the notification displaying module 144 may display a notification that includes the name and the current status of the contact.

In particular, according to an embodiment of the invention, if the detection module 142 detects an event A triggered through an application program, the notification displaying module 142 may directly display a notification of the event A on the touch screen 12 immediately, and the notification of the event may be shown in the displayed frame of the touch screen 12 in form of a prompt box. That is, according to the contents of the event A, the notification displaying module 142 may generate a corresponding prompt box and display the same onto any display region of the touch screen 12. On the other hand, if the detection module 142 detects several events triggered through several application programs, the notification displaying module 142 may arrange the notifications in any manner (e.g., in an overlapping pattern or in a tile pattern) and display the arranged notifications on any display region of the touch screen 12, for instance. The display region may be the entire displayed frame, any corner of the displayed frame, or any partial region of the displayed frame.

In another embodiment of the invention, the notification displaying module 144 not only can immediately display the notifications right after detection of such notifications but also can determine the time of displaying the notifications according to the operations of the user. For instance, when the detection module 142 detects the events triggered through the application programs, the notification display module 144 does not immediately display these notifications on the touch screen 12 but records the notification associated with the events and thereby establishes a notification list including at least one notification. Thereby, if the user performs a specific touch operation on the touch screen 12, e.g., the user performs a sliding operation from the edge of the touch screen 12 into the touch screen 12, the notification displaying module 144 displays the notification list including the notifications on the touch screen 12. That is, once the touch operation on the touch screen 12 satisfies the conditions of displaying the notification list, the notification displaying module 144 displays the notification list on the touch screen 12.

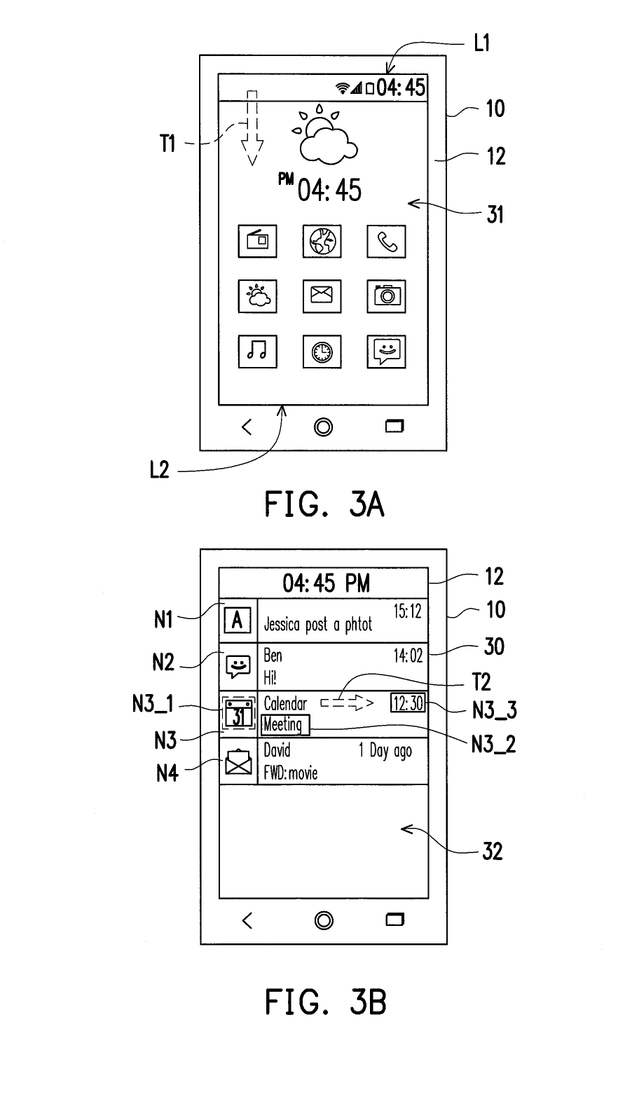

FIG. 3A and FIG. 3B are schematic diagrams of displaying a notification list according to an embodiment of the invention. In the present embodiment, the notification displaying module 144 receives the touch operation of sliding from an edge of the touch screen 12 into the touch screen 12 and thereby displays a notification list 30. The notification list 30 may include the notifications sequentially displayed according to a trigger time of each event. Specifically, with reference to FIG. 3A and FIG. 3B, when the electronic device 10 is in an unlocking state, the frame 31 is displayed on the touch screen 12, as shown in FIG. 3A. When the touch screen 125 detects the touch operation T1 of sliding from an edge L1 of the touch screen 12 into the touch screen 12, the notification displaying module 144 displays the drop-down notification list 30, as shown in FIG. 3B. In another embodiment, the touch operation that triggers the notification displaying module 144 to display the drop-down notification list 30 may also be the touch operation of sliding from an edge L2 of the touch screen 12 into the touch screen 12, which should not be construed as a limitation to the invention.

In the present embodiment, four notifications N1 to N4 are recorded in the notification list 30. The four notifications N1 to N4 respectively correspond to different application programs, and each of the four notifications N1 to N4 includes contents of an individual event and the trigger time of the event. The notifications N1 to N4 are sequentially arranged according to the trigger time of the events respectively included in the notifications N1 to N4. For instance, the notification N3 corresponds to the electronic calendar application program N3_1 and includes the event contents N3_2 and the trigger time N3_3 of the event.

In the present embodiment, the touch screen 12 is in an unlocking state, for instance; however, the invention is not limited thereto. In another embodiment of the invention, when the touch screen 12 of the electronic device 10 is in a locking state, the touch screen 12 merely displays the screen-locking frame, and most touch functions are limited. Nevertheless, the notification displaying module 144 can still display the notification list because it receives the touch operation (e.g., the touch operation T1 shown in FIG. 3A) triggered on the edge of the screen, and thereby the notification displaying module 144 can display the notification list.

Besides, if the detection module 142 detects any event triggered through the application program, not only the notification may be correspondingly displayed on the touch screen 12 according to the previous embodiment, but also the user may be prompted and reminded in another way of such event. According to the present embodiment, the functions of prompting and reminding the user collectively refer to the event notification function. To be specific, the event notification function may include one of or a combination of displaying the notification through the touch screen 12, providing a prompt sound, providing a prompt vibration, and providing a prompt light. For instance, when the e-mail application program receives a new e-mail, the electronic device 10 issues a sound or a light to prompt and remind the user.

It is noted that the way to display the event notification is not limited in the invention; the notification displaying module 144 may display individual notifications of each event on the touch screen 12 in any visible manner, and the time point at which the individual notifications of each event are displayed on the touch screen 12 may be determined according to actual requirements. In brief, the notification displaying module 144 may display the notifications triggered by individual events in various manners. Please refer to FIG. 3B below for further explanation of the invention.

Given that several notifications are already displayed on the touch screen 12, the interface control module 146 in step S250 receives a first touch operation performed on one of the notifications. According to the received first touch operation, deletion of the one of the notifications is prompted, and a blocking option is displayed. Particularly, the notification displaying module 144 displays the notifications on the touch screen 12 and provides the function that allows the user to drive the application programs corresponding to the notifications by clicking on the notifications displayed on the touch screen 12, so as to execute functions associated with the notifications. Alternatively, the notifications may be deleted by performing sliding operations on the notifications in a rightward or leftward direction. It should be mentioned that the user is not only allowed to delete the notifications or execute functions associated with the notifications but also permitted to tap on a blocking option to disable the event notification function associated with the notifications.

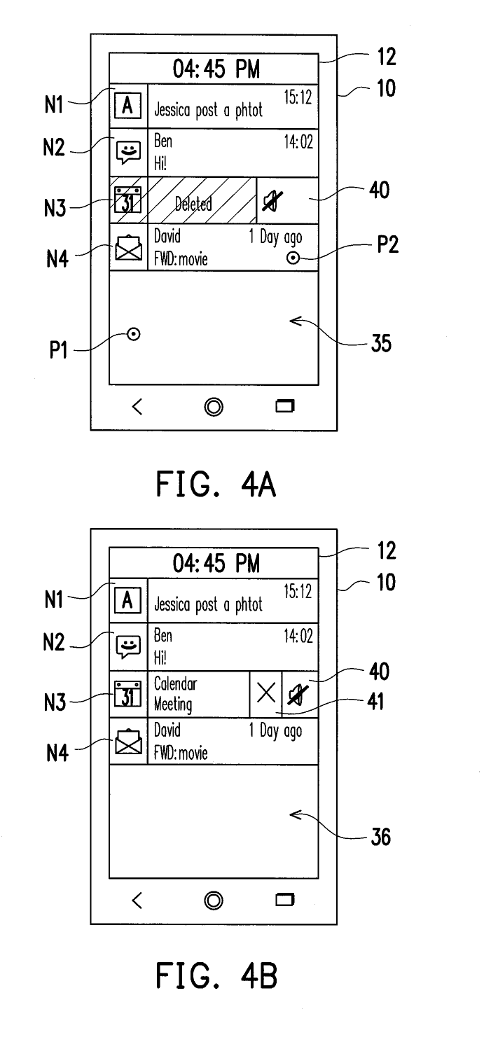

FIG. 4A and FIG. 4B are schematic diagrams of prompting deletion of a notification and displaying a blocking option according to an embodiment of the invention. With reference to FIG. 3B and FIG. 4A, in an embodiment of the invention, if the user performs a dragging operation T2 on the notification N3 (shown in FIG. 3B) from left to right, the interface control module 146 prompts “deleted” in the notification N3 and displays the blocking option 40. The blocking option 40 is, for instance, an icon that is displayed on the right of the notification N3 and can be touched by a finger, whereas the invention is not limited thereto. In another embodiment of the invention, the blocking option may be displayed in form of texts in other regions in the notification N3. It should be mentioned that the way to prompt a user to delete the notification N3 includes changing the visual appearance of the notification N3, e.g., changing at least one of the displayed location, the displayed size, the displayed color, the displayed definition, and the displayed transparency of the notification N3, such that the user may be prompted to delete the notification N3. If the interface control module 146 prompts the user to delete the notification N3, and any touch operation on the notification list excluding the notification N3 (e.g., on a point P1 or a point P2) is received, the notification N3 is accordingly deleted.

With reference to FIG. 3B and FIG. 4B, in another embodiment of the invention, if the user performs the dragging operation T2 on the notification N3 (shown in FIG. 3B) from left to right, the interface control module 146 not only displays the blocking option 40 in the notification N3 but also displays a “deletion” option 41; thereby, once a touch operation of the user on the deletion option is received subsequently, the notification N3 can be directly deleted. That is, in the present embodiment, the interface control module 146 can simultaneously provide the deletion option and the blocking option, such that the user may select to delete the notification or block the event notification function associated with individual events.

As shown in FIG. 2, if the interface control module 146 prompts the deletion of the notification and displays the blocking option, the management module 148 in step S270 receives a second touch operation performed on the blocking option, so as to disable the event notification function associated with the notification in the application program corresponding to the notification within a set period. Hence, within the following set period, the electronic device 10 does not execute the event notification function associated with the notification, and thus the user is not disturbed by the notification.

In an embodiment of the invention, when the user touches the blocking option, the management module 148 may further provide a time menu including at least one time option, such that the user may accordingly determine the time point of disabling the event notification function. Besides, once the management module 148 receives a touch operation of the user performed on one of the at least one time option, the management module 148 sets the set period according to a length of time corresponding to the time option being touched.

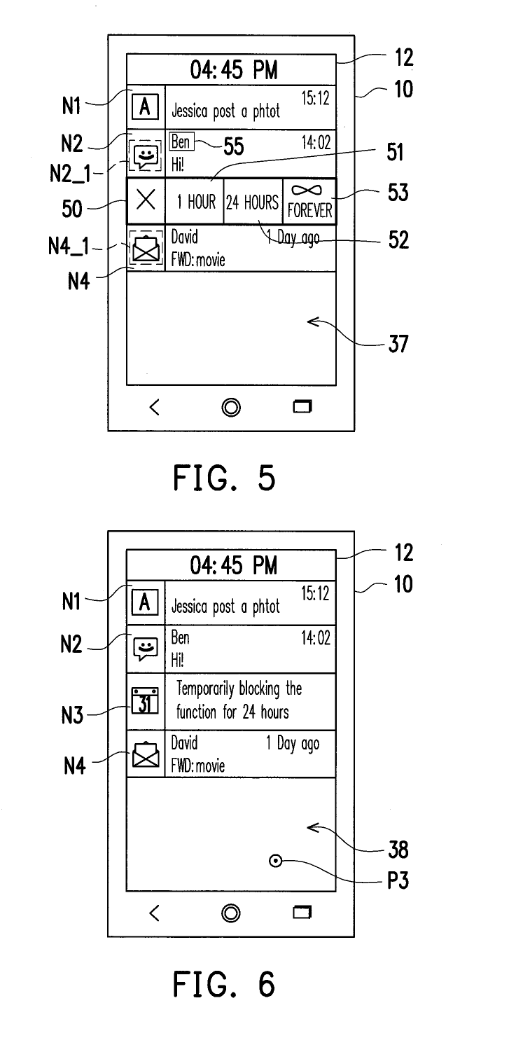

FIG. 5 is a schematic diagram of providing a time menu according to an embodiment of the invention. With reference to FIG. 4A and FIG. 5, when the management module 148 receives the second touch operation performed on the blocking option 40 in the notification N3 shown in FIG. 4A, the management module 148 displays a time menu 50 including time options 51 to 53 on a display frame 37. The time menu 50 includes the time option 51 representing 1 hour, the time option 52 representing 24 hours, and the time option 53 representing deletion forever. When the management module 148 receives the touch operation performed on the time option 52, the management module 148 sets the set period of disabling the event notification function to be 24 hours; when the management module 148 receives the touch operation performed on the time option 51, the management module 148 sets the set period of disabling the event notification function to be 1 hour.

That is, after the user determines the desirable time option, the management module 148 disables the event notification function associated with the notification N3 in the application program corresponding to the notification N3 within the set period. When the set period is over, the management module 148 re-enables the event notification function associated with the notification in the application program. After the user determines any desirable time option in the time menu 600, the management module 148 may prompt the user to set the set period in any manner, e.g., via sound, texts, and so on.

FIG. 6 is a schematic diagram of prompting disablement of an event notification function according to an embodiment of the invention. With reference to FIG. 5 and FIG. 6, if the user selects the time option 52 in the time menu 600, the management module 148 not only disables the event notification function associated with the notification N3 in the application program corresponding to the notification N3 but also prompts and reminds the user that the event notification function is already disabled; at the same time, the management module 148 displays the temporary disabling period (determined by the user) on a display frame 38. As shown in FIG. 6, if the user selects the time option 52 in the time menu 600, the management module 148 prompts “temporarily blocking the function for 24 hours” in the notification N3. After that, if the management module 148 receives the touch operation on the notification list excluding the notification N3 (e.g., the operation on a point P3), the notification selected by the user disappears from the notification list.

In view of the above, the user may temporarily disable the event notification function in the application program through performing simple steps, and the user is allowed to determine the set period of temporarily disabling the event notification function. Additionally, if the user selects to delete the notification or disable the event notification function associated with the notification, the notification selected by the user disappears from the notification list.

In the present embodiment, if the user already selects to delete the notification N3 or disable the event notification function associated with the notification N3, the notification N3 disappears from the notification list on the display frame 38. Similarly, if the interface control module 146 receives the touch operation of the user on the notification N2, the interface control module 146 prompts the user to delete the notification N2 and displays the blocking option of the notification N2.

It should be mentioned that the events triggered through some application programs may be associated with the contacts of the user of the electronic device 10. The contacts may be contacts in the phone book of the user or the friends in the friend list of social networking websites. For instance, if the detection module 142 detects that one contact posts a news feed via a social networking application program, the notification displaying module 144 correspondingly displays the notification including the information of the contact and the contents of the news feed on the touch screen 12; if the detection module 142 detects that one contact sends a message via an instant messaging (IM) application program, the notification displaying module 144 correspondingly displays the notification including the information of the contact and the contents of the message on the touch screen 12. As shown in FIG. 5, the notification list includes the notification N2 associated with the instant messaging application program, and the notification N2 includes the information of the contact (i.e., the name “Ben” of the contact).

It should be mentioned that the management module 148 disables the event notification function, and such disablement may be not only associated with the application program sending the notification but also associated with all events triggered by a contact who sends the notification in the application program corresponding to the notification or associated with all events triggered by a contact who sends the notification in all application programs of the electronic device 10. In brief, the management module 148 may temporarily block a notification triggered through a specific application program associated with the notification, a notification triggered by a specific contact in a specific application program, or a notification triggered by a specific contact in all of the application programs.

As exemplarily shown in FIG. 5, in an embodiment of the invention, if the user touches the blocking option of the notification N2, the management module 148 may acquire the information of the contact “Ben” who triggers the event. The management module 148 then disables the event notification function associated with all events triggered by the contact “Ben” in the application program N2_1 corresponding to the notification N2 within the set period. That is, the management module 148 monitors the subsequent events in the application program N2_1 and filters out the events triggered by the contact “Ben”. Once the set period is over, the management module 148 re-enables the event notification function associated with the events triggered by the contact “Ben” in the application program.

In another embodiment of the invention, if the user touches the blocking option of the notification N2, the management module 148 may acquire the information of the contact “Ben” who triggers the event. The management module 148 then disables the event notification function associated with all events triggered by the contact “Ben” in all application programs in the electronic device 10 within the set period. That is, the management module 148 monitors the subsequent events in all application programs and filters out the events triggered by the contact “Ben”. Once the set period is over, the management module 148 re-enables the event notification function associated with the events triggered by the contact “Ben” in all application programs. For instance, if the detection module 142 detects any event triggered by the contact “Ben” through the application program N4_1, the electronic device 10 does not send any notification associated with the triggered event to the user.

To sum up, in the method and the electronic device for managing the event notification, if the electronic device detects the event triggered through the application program and displays the corresponding notification on the screen, the operational interface of the electronic device may simultaneously prompt the deletion of the notification and provide the blocking option of disabling the event notification function. Thereby, the user does not need to perform additional operations, and the electronic device may spontaneously activate or disable the event notification function, which facilitates the use of the electronic device provided herein. Moreover, in an embodiment of the invention, the electronic device may further select to disable the event notification function corresponding to specific events according to the contents of the events, thus ensuring the operation of the electronic device to be more flexible and convenient.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A method for managing an event notification, adapted for an electronic device having a touch screen, the method comprising:
detecting at least one event triggered through at least one application program;
displaying a notification of each of the at least one event on the touch screen;
receiving a first touch operation performed on one of the notifications, and prompting deletion of the one of the notifications and displaying a blocking option according to the received first touch operation;
receiving a second touch operation performed on the blocking option and disabling an event notification function associated with the one of the notifications in the application program corresponding to the one of the notifications according to the received second touch operation within a set period.

2. The method as recited in claim 1, wherein the step of receiving the second touch operation performed on the blocking option and disabling the event notification function associated with the one of the notifications in the application program corresponding to the one of the notifications according to the received second touch operation within the set period further comprises:
displaying a time menu including at least one time option while receiving the second touch operation performed on the blocking option; and
receiving a third touch operation performed on one of the at least one time option and setting the set period according to a length of time corresponding to the one of the at least one time option.

3. The method as recited in claim 1, wherein after the step of disabling the event notification function associated with the one of the notifications in the application program corresponding to the one of the notifications within the set period, the method further comprises:
re-enabling the event notification function associated with the one of the notifications in the application program when the set period is over.

4. The method as recited in claim 1, wherein the step of disabling the event notification function associated with the one of the notifications in the application program corresponding to the one of the notifications within the set period comprises:
acquiring a contact triggering the at least one event; and
disabling the event notification function associated with all of the at least one event triggered by the contact in the application program corresponding to the one of the notifications within the set period.

5. The method as recited in claim 1, wherein the step of disabling the event notification function associated with the one of the notifications in the application program corresponding to the one of the notifications within the set period comprises:
acquiring a contact triggering the at least one event; and
disabling the event notification function associated with all of the at least one event triggered by the contact in all of the at least one application program within the set period.

6. The method as recited in claim 1, wherein the step of displaying the notification of each of the at least one event on the touch screen comprises:
receiving a fourth touch operation of sliding from an edge of the touch screen into the touch screen and displaying a notification list according to the received fourth touch operation, wherein the notification list comprises the notifications sequentially displayed according to a trigger time of each of the at least one event.

7. The method as recited in claim 6, wherein after the step of prompting the deletion of the one of the notifications and displaying the blocking option, the method further comprises:
receiving a fifth touch operation on the notification list excluding the one of the notifications and deleting the one of the notifications according to the received fifth touch operation.

8. The method as recited in claim 1, wherein the step of prompting the deletion of the one of the notifications comprises displaying a deletion option, so as to delete the one of the notifications after receiving a sixth touch operation performed on the deletion option.

9. The method as recited in claim 1, wherein the event notification function comprises one of or a combination of displaying the one of the notifications through the touch screen, providing a prompt sound, providing a prompt vibration, and providing a prompt light.

10. An electronic device comprising:
a touch screen;
a storage unit, configured to record a plurality of modules and at least one application program; and
at least one processing unit, coupled to the touch screen and the storage unit, and configured to access and execute the modules recorded in the storage unit, the modules comprising:
a detection module, detecting at least one event triggered through the at least one application program;
a notification displaying module, displaying a notification of each of the at least one event on the touch screen;
an interface control module, receiving a first touch operation performed on one of the notifications and prompting deletion of the one of the notifications and displaying a blocking option according to the received first touch operation; and
a management module, receiving a second touch operation performed on the blocking option and disabling an event notification function associated with the one of the notifications in the application program corresponding to the one of the notifications according to the received second touch operation within a set period.

11. The electronic device as recited in claim 10, wherein when the management module receives the second touch operation performed on the blocking option, the management module displays a time menu including at least one time option, receives a third touch operation performed on one of the at least one time option, and sets the set period according to a length of time corresponding to the one of the at least one time option.

12. The electronic device as recited in claim 10, wherein when the set period is over, the management module re-enables the event notification function associated with the one of the notifications in the at least one application program.

13. The electronic device as recited in claim 10, wherein the management module acquires a contact triggering the at least one event and disables the event notification function associated with all of the at least one event triggered by the contact in the application program corresponding to the one of the notifications within the set period.

14. The electronic device as recited in claim 10, wherein the management module acquires a contact triggering the at least one event and disables the event notification function associated with all of the at least one event triggered by the contact in all of the at least one application program within the set period.

15. The electronic device as recited in claim 10, wherein the notification displaying module receives a fourth touch operation of sliding from an edge of the touch screen into the touch screen and displays a notification list according to the received fourth touch operation, wherein the notification list comprises the notifications sequentially displayed according to a trigger time of each of the at least one event.

16. The electronic device as recited in claim 15, wherein the interface control module receives a fifth touch operation on the notification list excluding the one of the notifications and deleting the one of the notifications according to the received fifth touch operation.

17. The electronic device as recited in claim 10, wherein the interface control module displays a deletion option, so as to delete the one of the notifications after receiving a sixth touch operation performed on the deletion option.

18. The electronic device as recited in claim 10, wherein the event notification function comprises one of or a combination of displaying the one of the notifications through the touch screen, providing a prompt sound, providing a prompt vibration, and providing a prompt light.
